(19) United States
(12) Patent Application Publication
(10) Pub. No.: US 2026/0103646 A1
(43) Pub. Date: Apr. 16, 2026

(54) METHOD FOR PRODUCING BIO OR FOSSIL FUELS THROUGH LIGHT OLEFINS OLIGOMERIZATION OVER ZEOLITE CATALYSTS AND A SYSTEM FOR PRODUCING THE SAME

(71) Applicant: Lummus Technology LLC

(72) Inventors: Yubing Lu, Houston, TX (US); Fredy Cabrales, Houston, TX (US); Liang Chen, Houston, TX (US); Jackeline Medina Bolivar, Houston, TX (US); Matthew Ulrich, Houston, TX (US); Manoj Som, Houston, TX (US); Zhiliang Wang, Houston, TX (US)

(73) Assignee: Lummus Technology LLC, (omitted)

(21) Appl. No.: 19/358,217

(22) Filed: Oct. 14, 2025

Related U.S. Application Data
(60) Provisional application No. 63/707,638, filed on Oct. 15, 2024.

(51) Int. Cl. C10G 67/14; B01D 3/14; B01J 8/02; B01J 8/04; C10G 50/00

(52) U.S. Cl. CPC C10G 67/14; B01D 3/143; B01J 8/0278; B01J 8/0492; C10G 50/00; B01J 2208/00176; B01J 2208/00362; C10G 2300/1011; C10G 2300/1088; C10G 2300/1092; C10G 2300/70; C10G 2400/04; C10G 2400/08

(57) ABSTRACT

A process and system for producing bio or fossil fuels is provided. The process includes: feeding mixed hydrocarbon to a fixed-bed reactor system containing a zeolite catalyst; operating the fixed-bed reactor system for oligomerization of one or more C3-C8 hydrocarbons to form an oligomerized effluent; separating the oligomerized effluent into a C3-fraction, a gas stream, and a liquid stream in a gas/liquid separation unit; feeding at least a first portion of the liquid stream to a distillation unit; recycling at least a second portion of the liquid stream to the fixed-bed reactor system; separating the first portion of the liquid stream in the distillation unit into, a light fraction and a heavy fraction; and recycling the light fraction to the fixed-bed reactor system.

### FIELD OF THE DISCLOSURE

Embodiments disclosed herein generally relate to systems and processes for the production of bio or fossil fuels through light olefins oligomerization over zeolite catalysts.

### BACKGROUND

Oligomerization of light olefins such as n-butenes in the presence of an acid-based catalyst (e.g., zeolite) is a key route to the production of bio-or fossil-based fuel range hydrocarbons. For example, U.S. Pat. No. 6,689,927 discloses a process for the production of C8 alkenes with high selectivities to 2,4,4-trimethylpentene by the oligomerization of isobutene and/or n-butene. Furthermore, U.S. Pat. Nos. 8,373,012 and 11,078,433 involve butanol feed to produce jet fuel via dehydrogenation, oligomerization and hydrogenation. In detail, iso-butene is oligomerized to obtain oligomerized products, the oligomerized products are separated into a light fraction (C8 fraction) further dimerized into C16 fraction, and C8-C12 fraction is further processed into jet fuel, and heavier fraction.

Furthermore, U.S. Pat. Nos. 7,759,533, 7,411,105, 7,572,946, 7,994,377, and 4,393,259 and European U.S. Pat. No. 1,765,747 disclose n-butene oligomerization involving a single fixed-bed reactor and variant catalysts, followed by separating the oligomerized products into higher olefin and lighter olefin and recycling unreacted C4 olefins, gas phase inert or H₂ to the feed stream. In such processes, the oligomerization is combined with other processes such as alkane dehydrogenation or butanol dehydration processes. However, oligomerization of n-butenes with acid-based catalysts requires harsh operating conditions which leads to undesired reactions, such as cracking, hydrogen transfer or disproportionation reactions, heavy hydrocarbon accumulation, and severe coke formation, and lowering of catalyst lifetime and thus the prior arts mostly focused on the catalyst selection and product separation, without addressing deactivation of acid-based catalysts. Accordingly, there exists a continuing need for improving catalyst deactivation for continuous process for producing bio- or fossil-based fuel range products.

### SUMMARY

Systems and processes for producing bio or fossil fuels through light olefins oligomerization over zeolite catalysts have now been developed to improve catalyst lifetime and to produce sustainable bio or fossil fuels.

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a process for producing bio or fossil fuels. The process includes: feeding mixed hydrocarbon to a fixed-bed reactor system containing a zeolite catalyst; operating the fixed-bed reactor system for oligomerization of one or more C3-C8 hydrocarbons to form an oligomerized effluent; separating the oligomerized effluent into a C3-fraction, a gas stream, and a liquid stream in a gas/liquid separation unit; feeding at least a first portion of the liquid stream to a distillation unit; recycling at least a second portion of the liquid stream to the fixed-bed reactor system; separating the first portion of the liquid stream in the distillation unit into, a light fraction, such as a C4-C8 fraction as a jet fuel or a C4-C11 fraction as a diesel and a heavy fraction, such as a C9+ fraction as a jet fuel or a C12+ fraction as a diesel; and recycling the light fraction to the fixed-bed reactor system.

In another aspect, embodiments disclosed herein relate to a system for producing bio or fossil fuels. The system includes: a fixed-bed reactor system containing a zeolite catalyst for oligomerization of one or more C3-C8 hydrocarbons to form an oligomerized effluent; a gas/liquid separation unit to separate an oligomerized effluent from the fixed-bed reactor system into a gas stream and a liquid stream, wherein the liquid stream comprises a first portion and a second portion; an internal recycle system to recycle at least a second portion of the liquid stream to the fixed-bed reactor system; a distillation unit to separate the first portion of the liquid stream into, a light fraction and a heavy fraction; an external recycle system to recycle the light fraction to the fixed-bed reactor system; and a hydrogenation unit to hydrogenate the heavy fraction to form one or more heavy branched paraffins. The system further includes a fractionation system for fractionating the heavy branched paraffins into a light fraction, a jet/diesel fraction, and a heavy fraction.

In one or more embodiments, the mixed hydrocarbon may contain one or more components of propene, 1-butene, 2-butene, isobutene, pentene, hexene, and octene and the oligomerized effluent may contain one or more oligomers of propene, 1-butene, 2-butene, isobutene, pentene, hexene and octene.

Other aspects and advantages of the claimed subject matter will be apparent from the following description and the appended claims.

### BRIEF DESCRIPTION OF THE DRAWINGS

FIGS. 1-4 are simplified process flow diagrams of a system for producing bio or fossil fuels in accordance with one or more embodiments.

The drawings contain reference numbers to identify components or features. Across the drawings, like numbers represent like parts.

### DETAILED DESCRIPTION

In the following Detailed Description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Embodiments herein relate to production of bio or fossil fuels through oligomerization of mixed hydrocarbon over zeolite catalysts. The oligomerization may be conducted in a fixed-bed reactor system, which may contain a zeolite catalyst. In some embodiments of the present disclosure, the mixed hydrocarbon may contain C4 hydrocarbons including 1-butene, 2-butene, isobutene, and may further contain C3-C8 olefins including propylene, pentene, hexene, and octene. The mixed hydrocarbon may be fed to a fixed-bed reactor system to oligomerize the mixed hydrocarbon, thereby producing an oligomerized effluent containing highly branched jet or diesel range olefins.

In one or more embodiments, the fixed-bed reactor system may include one or more fixed-bed reactors. The fixed-bed reactor(s) may be any type of reactor which facilitates oligomerization with a zeolite catalyst. Examples of zeolite catalysts may include, but are not limited to, zeolite beta, ferrierite, Y-zeolite, ZSM-5, HZSM-5, ZSM-22, MMT-zeolite, surface modified zeolite, amorphous silica-alumina catalysts, metal-doped zeolite catalysts thereof, and surface-modified zeolite catalysts thereof. Examples of metal that may be doped in the catalysts listed above may include, but are not limited to Ni, Co, Fe, Zn, Zr, Mo, Ce, Cu, W, Y, La, Be, Cr, Pt, Pd, and Rh. Furthermore, the surface of the catalysts may be modified with, for example, ion-exchange with Na, Li or Mg, acid treatment, alkaline treatment, salt treatment, heat treatment and modification with surfactants, among others. The fixed-bed reactor(s) may be vertical or horizontal. The reactor system useful in embodiments disclosed herein may include a series of multiple reactors or multiple reactors in parallel. A person of ordinary skill in the art would recognize that other types of reactors may also be used.

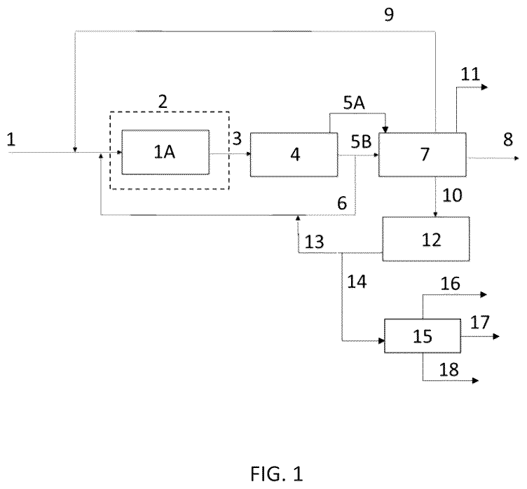

As shown in FIGS. 1-4, the mixed hydrocarbon feed 1 may be fed to the fixed-bed reactor system 2. The mixed hydrocarbon is oligomerized in the fixed-bed reactor system 2, producing an oligomerized effluent 3, 30, 32 containing, for example, butene oligomers, isobutane, and butane. In one or more embodiments, the fixed-bed reactor system 2 may contain one fixed-bed reactor 1A, as shown in FIG. 1. Alternatively, in one or more embodiments, the fixed-bed reactor system may contain a plurality of fixed-bed reactors arranged in parallel, series, or parallel and series. Details of such embodiments will be described later.

Systems useful in production of bio or fossil fuels may also include a gas/liquid separating unit 4 for separating the oligomerized effluent 3, 30, 32 into a gas stream and a liquid stream, and a distillation unit 7, as shown in FIGS. 1-4. The gas stream may be fed into distillation unit 7 at a tray elevation above the liquid stream in order to provide more controlled column dynamics. The oligomerized effluent 3 may be first cooled down to ambient temperature with a cooling system or heat exchanger before sending the oligomerized effluent 3 from the fixed-bed reactor system 2 to a gas/liquid separating unit 4 where the condensed liquid phase is separated from the vapors. The gas stream may contain light hydrocarbons, such as C3-C4 hydrocarbons.

As shown in FIGS. 1-4, a C3-fraction, a gas stream 5A and a portion of the liquid stream 5B (“first liquid fraction”) may be fed to the distillation unit 7, and another portion of the liquid stream (“second liquid fraction”) may be recycled back to the fixed-bed reactor system 2 as recycle stream 6 (internal recycle). The C3-fraction may be formed as a byproduct of oligomerization of the mixed hydrocarbon, and may include, for example, methane, ethane, ethylene, propane, and propylene. In one or more embodiments, a mass ratio of the first liquid fraction to the second liquid fraction ranges from 1:10 to 10:1. In some embodiments, the gas stream 5A is recovered directly from the separating unit 4 and not fed to the distillation unit 7.

The purpose of the distillation unit 7 is to separate a portion of the liquid stream 5B, fed from the gas/liquid separating unit 4, into, a light fraction 9 containing a C4-C8 fraction as a jet fuel or a C4-C11 fraction as a diesel, a heavy fraction 10 containing a C9+ fraction as a jet fuel or a C12+ fraction as a diesel, and optionally a heavier fraction 8 containing a C19+ fraction or a C21+ fraction. The amount of light fraction and heavy fraction may vary depending on the amount of the first liquid fraction fed to the distillation unit and the amount of the second liquid fraction recycled back to the fixed-bed reactor system 2. Gases 11 including carbon dioxide, nitrogen, and other light gases may be vented from the distillation unit 7 (or gas stream 5A from separating unit 4) and may be further processed to recover the hydrocarbons therein, flared, or otherwise disposed. The light fraction 9 may be recycled back to the fixed-bed reactor system 2 as an external recycle. The heavier fraction 8 may be collected as a product and processed within a refinery to produce various desired end products. Finally, the heavy fraction 10 may be fed to a hydrogenation unit 12 to hydrogenate the heavy fraction 10 to obtain heavy branched paraffins 13 (C9+ fraction as a jet fuel or C12+ as diesel). In some embodiments, a portion of heavy branched paraffins 14 is fed to a fractionation system 15 to fractionate the heavy branched paraffins 14 into a light hydrogenated fraction 16, a jet/diesel fraction 17, and heavy hydrogenated fraction 18. Light hydrogenated fraction 16 may contain C4-C8 or C4-C11 hydrocarbons, for example, while jet/diesel fraction 17 may contain C9 or C11 to C18 or C20 hydrocarbons, and heavy hydrogenated fraction 18 may include C19+ or C21+ hydrocarbons, depending upon whether jet fuel or diesel fuel is the targeted fuel product. The jet/diesel fraction 17 is taken as a target hydrogenated jet or diesel product (i.e., branched jet-range or diesel-range paraffins).

Further, a portion of the heavy branched paraffins 13 may be recycled back to the fixed-bed reactor system 2 alone, or with the recycle stream 6 (internal recycle) which is recycled back from the gas/liquid separation unit 4.

The process and system herein utilizing internal and external recycles may benefit operating conditions to aid control of the selectivity to jet or diesel range components. In one or more embodiments, the mass ratio of the mixed hydrocarbon feed 1 to the total of the recycle stream 6 (internal recycle), light fraction 9 (external recycle), and the heavy branched paraffins 13 may be 10:1 to 1:15, such as in the range from 8:1 to 1:8, or in the range from 5:1 to 1:5. The mass ratio of the mixed hydrocarbon feed 1 to the recycle stream 6 (internal recycle) may be 10:1 to 1:10, such as in the range from 7:1 to 1:7, in the range from 5:1 to 1:5, or in the range from 3:1 to 1:3. The mass ratio of the mixed hydrocarbon feed 1 to light fraction 9 (external recycle) may be 10:1 to 1:10, such as in the range from 7:1 to 1:7, in the range from 5:1 to 1:5, or in the range from 3:1 to 1:3. The mass ratio of the mixed hydrocarbon feed 1 to the heavy branched paraffins 13 may be 10:1 to 1:10, such as in the range from 7:1 to 1:7, in the range from 5:1 to 1:5, or in the range from 3:1 to 1:3. Adjusting each of the above ratios may provide the desired selectivity and may improve deactivation of the catalyst of the fixed-bed reactor system.

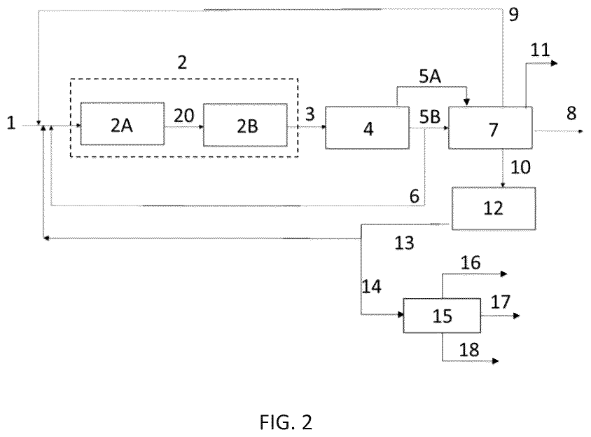

As discussed above, the fixed-bed reactor system may contain a plurality of fixed-bed reactors arranged in parallel, series, or parallel and series. FIG. 2 shows a process flow diagram of a system for producing bio or fossil fuels containing a fixed bed reactor system 2 including a first fixed-bed reactor 2A and a second fixed-bed reactor 2B, in accordance with one or more embodiments. The two fixed-bed reactors 2A and 2B may be arranged in series. The mixed hydrocarbon may be fed to a first fixed-bed reactor 2A from a mixed hydrocarbon feed 1 to form an intermediate oligomerized effluent 20, and then, the obtained intermediate oligomerized effluent 20 may be fed to the second fixed-bed reactor 2B.

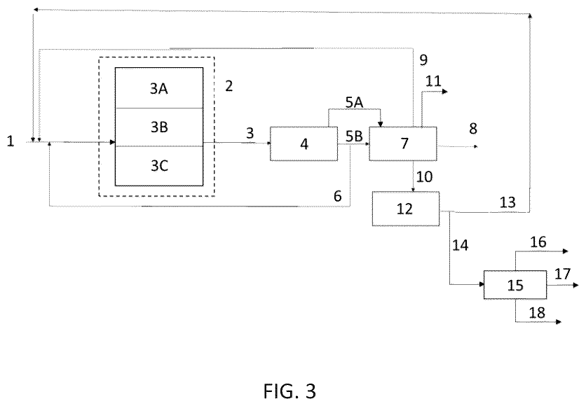

FIG. 3 shows a process flow diagram of a system for producing bio or fossil fuels containing a fixed-bed reactor system 2 including a first fixed-bed reactor 3A, a second fixed-bed reactor 3B, and a third fixed-bed reactor 3C, in accordance with one or more embodiments. In the fixed-bed reactor system 2, the three fixed-bed reactors 3A-3C may be staggered, such that the operation cycle and regeneration cycle of the reactors do not overlap. The regeneration cycle disclosed herein refers to burning off or sweeping off a deposited coke and/or heavy compounds on the surface of the zeolite catalyst with an additional feed such as an air feed (alternatively oxygen-enriched air or oxygen), a hydrogen (“H₂”) feed, a nitrogen (“N₂”) feed, or a mixture of H₂ and N₂ feed. The above gases may be fed, for example, as an air feed to the fixed-bed reactor system (not shown in FIG. 3). In some embodiments, the system may also include a control system configured for operating two fixed-bed reactors in an operation cycle; and operating one reactor in a regeneration cycle. The temperature of the regeneration cycle may be in a range from 200° C. to 600° C. For example, in one or more embodiments, the temperature of the regeneration cycle may be within a range from a lower limit of one of 200, 205, 210, 215, 220, 240, 260, 280, 300, 320, 340, 360, 380, and 400° C., to an upper limit of one of 400, 420, 440, 460, 480, 500, 520, 540, 560, 580, 585, 590, 595, and 600° C., where any lower limit may be paired with any mathematically compatible upper limit.

In some embodiments, the process may include operating a first fixed-bed reactor 3A in a regeneration cycle and operating a second and a third fixed-bed reactors (3B and 3C) for oligomerization of the mixed hydrocarbon. For example, the mixed hydrocarbon may be fed to a second fixed-bed reactor 3B in the fixed-bed reactor system to obtain an intermediate oligomerized effluent (not shown in FIG. 3), and then the intermediate oligomerized effluent may be recovered from the second fixed-bed reactor 3B. The intermediate oligomerized effluent may then be fed to a third fixed-bed reactor 3C in the fixed-bed reactor system 2, which is in an operation cycle. The oligomerized effluent is then recovered from the third fixed-bed reactor 3C. While the second and third fixed-bed reactors (3B and 3C) are in an operation cycle to oligomerize the mixed hydrocarbon, the first fixed-bed reactor 3A may be in a regeneration cycle such that the zeolite catalyst may be regenerated. After the zeolite catalyst of the first fixed-bed reactor 3A is regenerated, the first fixed-bed reactor 3A may be switched from regeneration cycle to operation cycle and one of the second and third fixed-bed reactors (3B and 3C) may be switched from operation cycle to regeneration cycle with a control system. Such fixed-bed reactor system of embodiments disclosed herein may improve deactivation of the zeolite catalysts in the fixed-bed reactors and control the temperature during the startup of the production of the jet fuel, thereby improving the yield of the jet fuel range product and ensuring continuous operation. While described as being operated in series, the first, second, and third fixed-bed reactors could also be operated in parallel, while still utilizing the staggered reactor cycling for catalyst regeneration.

Furthermore, the fixed-bed reactor system may further include a cooling system or a heat exchanger for cooling the intermediate oligomerized effluent. The process of cooling the intermediate oligomerized effluent will be discussed below.

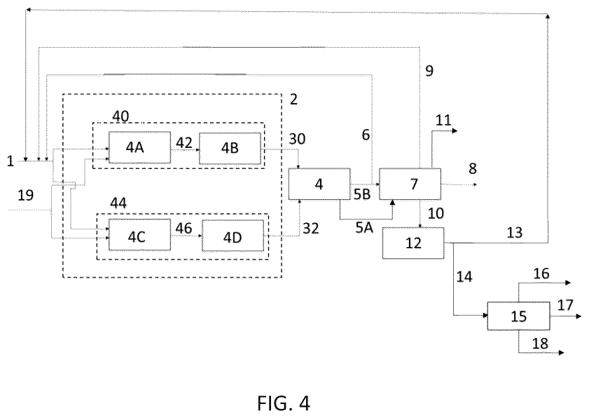

FIG. 4 shows a process flow diagram of a system for producing bio or fossil fuels containing a fixed bed reactor system 2 including a first fixed-bed reactor 4A, a second fixed-bed reactor 4B, a third fixed-bed reactor 4C, and a fourth fixed-bed reactor 4D, in accordance with one or more embodiments. As shown in FIG. 4, the system includes two sets of fixed-bed reactor systems 40 and 44 arranged in parallel, each set including two fixed-bed reactors in series.

In some embodiments, such as where each of the first and second set of fixed-bed reactor systems (40 and 44) comprise two fixed-bed reactors (4A and 4B in the first set 40 and 4C and 4D in the second set 44), the system may also include a control system configured for: operating the fixed-bed reactors in one set of the fixed-bed reactor system in an operation cycle; and operating the fixed-bed reactors in another set of the fixed-bed reactor system in a regeneration cycle. During the operation cycle of the first set of the fixed-bed reactor system 40, the mixed hydrocarbon may be fed to a first fixed-bed reactor 4A from a mixed hydrocarbon feed 1, an intermediate oligomerized effluent 42 may be recovered from the first fixed-bed reactor 4A and then fed to a second fixed-bed reactor 4B. Then, the second fixed-bed reactor 4B further oligomerize the intermediate oligomerized effluent 42 producing an oligomerized effluent 30. When the first set of the fixed-bed reactor system 40 is deactivated, it may be switched to regeneration cycle and the second set of the fixed-bed reactor system 44, which was in regeneration cycle, may be switched to an operation cycle such that the third and fourth fixed-bed reactors (4C and 4D) operate to oligomerize the mixed hydrocarbon fed from the mixed hydrocarbon feed 1. An intermediate oligomerized effluent 46 may be recovered from the third fixed-bed reactor 4C and then fed to the fourth fixed-bed reactor 4D for further oligomerization, thereby producing an oligomerized effluent 32. Such fixed-bed reactor system of embodiments disclosed herein make it possible for continuous operation of fixed-bed reactors for oligomerization.

Furthermore, each set of the fixed-bed reactor system 40 and 44 may further contain a cooling system or heat exchanger (not shown in FIG. 4) to cool the intermediate oligomerized effluent 42 and 46. The process of cooling the intermediate oligomerized effluent is as discussed below.

Alternatively, in some embodiments, fixed-bed reactor systems 40 and 44 may be in operating to oligomerize the mixed hydrocarbon feed in parallel in order to increase capacity. Additionally, while only three different reactor configurations have been discussed with respect to FIGS. 2-4, it is additionally contemplated that other reactor configurations may be used which are combinations of the configurations presented in FIGS. 2-4. For example, a third set of fixed-bed reactors may be added to the configuration of FIG. 4 and operated in staggered fashion as described with respect to the configuration of FIG. 3.

In one or more embodiments, the fixed-bead reactor system may be operated at a pressure in a range from 20 bars to 50 bars. For example, in one or more embodiments, the operating pressure of the fixed-bed reactors may be within a range from a lower limit of one of 20, 22, 24, 26, 28, 30, 32, and 34 bars, to an upper limit of one of 36, 38, 40, 42, 44, 46, 48, and 50 bars, where any lower limit may be paired with any mathematically compatible upper limit.

Furthermore, the fixed-bed reactor may be operated in a temperature in a range from 200° C. to 300° C. For example, in one or more embodiments, the temperature of the fixed bed reactor may be within a range from a lower limit of one of 200, 205, 210, 215, 220, 240, and 260° C. to an upper limit of one of 240, 260, 280, 285, 290, 295, and 300° C., where any lower limit may be paired with any mathematically compatible upper limit. Temperature above such range would lead to higher rate of side reactions such as cracking, disproportionation, hydrogen transfer, ring formation, further oligomerization to form heavy olefins, which could lead to a surge in the byproducts such as aromatic, light alkane, and heavier products outside jet fuel or diesel fuel range (i.e., C19+ or C21+ hydrocarbon and coke).

As discussed above, in one or more embodiments, the system for producing bio or fossil fuels may further include a cooling system or a heat exchanger for cooling the intermediate oligomerized effluent. The intermediate oligomerized effluent may be cooled before feeding the intermediate oligomerized effluent to another fixed-bed reactor.

The intermediate oligomerized effluent may be cooled to a temperature in a range from 150° C. to 250° C. For example, in one or more embodiments, the temperature of the fixed bed reactor may be within a range from a lower limit of one of 150, 155, 160, 165, 170, 190, and 210° C. to an upper limit of one of 190, 210, 230, 235, 240, 245, and 250° C., where any lower limit may be paired with any mathematically compatible upper limit. Cooling the intermediate oligomerized effluent may avoid over-heating of the zeolite catalysts in the fixed-bed reactor and mitigate deactivation of the zeolite catalyst.

In one or more embodiments, the intermediate oligomerized effluent may be cooled with any cooling system or a heat exchanger via direct heat exchange or indirect heat exchange. For example, the intermediate oligomerized effluent may be cooled by direct heat exchange by mixing with a portion of the recycle stream 6 (internal recycle), and a second portion may be mixed with the intermediate oligomerized effluent.

In other embodiments, indirect heat exchange may be used to cool the intermediate oligomerized effluent. For example, a feed-effluent exchanger may be provided to pre-heat the mixed hydrocarbon feed while cooling the intermediate oligomerized effluent. The pre-heating of the mixed hydrocarbon will be described later.

In other embodiments, a combination of direct and indirect cooling may be used to achieve a desired feed temperature of the intermediate oligomerized effluent to the second fixed bed reactor.

In some embodiments, the mixed hydrocarbon may be pre-heated to adjust a reaction temperature of the oligomerization, before oligomerizing the mixed hydrocarbon. The mixed hydrocarbon may be pre-heated to a temperature of 160° C. or more, such as, 180° C. or more, 200° C. or more, 220° C. or more, 240° C. or more, and 260° C. or more.

The system may further include an additional feed 19. The additional feed 19 may be an air feed (alternatively oxygen-enriched air or oxygen), a H₂ feed, a N₂ feed, or a mixture of H₂ and N₂ feed. As shown in FIG. 4, air, H₂, N₂, or a mixture of H₂ and N₂ may be fed from the feed 19 to the fixed-bed reactor system 2 for activation or regeneration of the catalyst when needed. The temperature of the activation or regeneration of the catalyst may be in a range from 200° C. to 600° C. For example, in one or more embodiments, the temperature of the activation or regeneration of the catalyst may be within a range from a lower limit of one of 200, 205, 210, 215, 220, 240, 260, 280, 300, 320, 340, 360, 380, and 400° C., to an upper limit of one of 400, 420, 440, 460, 480, 500, 520, 540, 560, 580, 585, 590, 595, and 600° C., where any lower limit may be paired with any mathematically compatible upper limit.

The system and process for producing bio or fossil fuels disclosed herein integrate internal and external recycles with optimized operating conditions, control the selectivity to jet fuel or diesel fuel range components, improves deactivation of zeolite catalyst and temperature control during start-ups and operations, thereby improving the yield of the jet fuel or diesel fuel range products. The integrated recycle systems significantly slow down deactivation of zeolite catalyst and improve temperature control during start-ups and operations, thereby improving the jet fuel or diesel yield. In detail, the integrated internal and external systems maximize the hydrocarbon oligomerization by properly controlling the olefin concentration in the catalyst environment and recycle light products to produce desired jet fuel or diesel fuel range products.

Furthermore, utilization of a plurality of fixed-bed reactors disclosed herein improve the flexibility of temperature control and avoids overheating of the zeolite catalyst, improve product selection, and further improves on-stream time of the production process which enables continuous operation of the system.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

When the word “approximately” or “about” are used, this term may mean that there can be a variance in value of up to ±10%, of up to 5%, of up to 2%, of up to 1%, of up to 0.5%, of up to 0.1%, or up to 0.01%.

“Optionally” and all grammatical variations thereof as used refers to a subsequently described event or circumstance that may or may not occur. The description includes instances where the event or circumstance occurs and instances where it does not occur.

The term “substantially” and all grammatical variations thereof as used refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Ranges may be expressed as from about one particular value to about another particular value, inclusive. When such a range is expressed, it is to be understood that another one or more embodiments are from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

Thus, particular implementations of the subject matter have been described. Other implementations are within the scope of the following claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A process for producing bio or fossil fuels, the process comprising:
feeding mixed hydrocarbon to a fixed-bed reactor system containing a zeolite catalyst, wherein the mixed hydrocarbon comprises one or more components of propene, 1-butene, 2-butene, isobutene, pentene, hexene, and octene;
operating the fixed-bed reactor system for oligomerization of one or more C3-C8 hydrocarbons to form an oligomerized effluent comprising one or more oligomers of propene, 1-butene, 2-butene, isobutene, pentene, hexene and octene;
separating the oligomerized effluent into a C3-fraction, a gas stream, and a liquid stream in a gas/liquid separation unit;
feeding at least a first portion of the liquid stream to a distillation unit;
recycling at least a second portion of the liquid stream to the fixed-bed reactor system;
separating the first portion of the liquid stream in the distillation unit into a light fraction and a heavy fraction; and
recycling the light fraction to the fixed-bed reactor system,
wherein, when jet fuel is a targeted fuel product, the light fraction comprises a C4-C8 fraction and the heavy fraction comprises a C9+ fraction, and
wherein, when diesel fuel is the targeted fuel product, the light fraction comprises a C4-C11 fraction and the heavy fraction comprises a C12+ fraction.

2. The process of claim 1, further comprising:
hydrogenating the heavy fraction in a hydrogenation unit to form a product stream comprising one or more heavy branched paraffins;
fractionating a portion of the heavy branched paraffins into a light hydrogenated fraction, a jet or diesel fraction, and a heavy hydrogenated fraction, wherein the light hydrogenated fraction comprises C4-C8 hydrocarbons or C4-C11 hydrocarbons, and the heavy hydrogenated fraction comprise C19+ hydrocarbons or C21+ hydrocarbons; and
mixing a second portion of the heavy branched paraffins with the second portion of the liquid stream and recycling a mixture of the portion of the heavy branched paraffins and the second portion of the liquid stream to the fixed-bed reactor system.

3. The process of claim 1, further comprising, before the oligomerization, pre-heating the mixed hydrocarbon to a temperature of more than 160° C.

4. The process of claim 1, operating the fixed-bed reactor system at a pressure in a range from 20 bars to 50 bars.

5. The process of claim 2, wherein a mass ratio of the mixed hydrocarbon to a total of the second portion of the liquid stream, the light fraction, and the second portion of heavy branched paraffins fed to the fixed-bed reactor system is in a range from 10:1 to 1:15.

6. The process of claim 1, comprising:
feeding the mixed hydrocarbon to a first fixed-bed reactor in the fixed-bed reactor system;
recovering an intermediate oligomerized effluent;
feeding the intermediate oligomerized effluent to a second fixed-bed reactor in the fixed-bed reactor system; and
recovering the oligomerized effluent.

7. The process of claim 6, further comprising, before feeding the intermediate oligomerized effluent to the second fixed-bed reactor, cooling the intermediate oligomerized effluent to a temperature in a range from 150° C. to 250° C.

8. The process of claim 6, further comprising:
cooling the intermediate oligomerized effluent via direct heat exchange by mixing intermediate oligomerized effluent with one or more of the portion of the second portion of the liquid stream the light fraction.

9. The process of claim 6, further comprising:
cooling the intermediate oligomerized effluent via indirect heat exchange by mixing intermediate oligomerized effluent with one or more of the portion of the second portion of the liquid stream the light fraction; and
mixing a cooled intermediate oligomerized effluent with the mixed hydrocarbon to pre-heat the mixed hydrocarbon.

10. The process of claim 6, further comprising:
cooling the intermediate oligomerized effluent via indirect heat exchange with a feed-effluent exchanger.

11. The process of claim 1, comprising:
feeding the mixed hydrocarbon to a first fixed-bed reactor in the fixed-bed reactor system;
recovering an intermediate oligomerized effluent;
feeding the intermediate oligomerized effluent to a second fixed-bed reactor or a third fixed-bed reactor in the fixed-bed reactor system; and
recovering the oligomerized effluent from the second fixed-bed reactor or the third fixed-bed reactor.

12. The process of claim 11, further comprising:
operating the first fixed-bed reactor, the second fixed-bed reactor, and the third fixed-bed reactor in a cyclic operation including regeneration cycle;
controlling the operation of the first fixed-bed reactor, the second fixed-bed reactor, and the third fixed-bed reactor in a staggered fashion such that, in the fixed-bed reactor system, no two fixed-bed reactors are in the regeneration cycle at the same time;
wherein in the operating and controlling, one or more feeds selected from the group consisting of an air feed, a hydrogen feed, and a nitrogen feed is fed to the fixed-bed reactor system, and
a temperature of the operating and controlling is in a range from 200° C. to 600° C.

13. The process of claim 1, comprising:
feeding the mixed hydrocarbon to a first fixed-bed reactor in a first set of the fixed-bed reactor system or to a third fixed-bed reactor in a second set of the fixed-bed reactor system;
recovering an intermediate oligomerized effluent from the first fixed-bed reactor or the third fixed-bed reactor;
feeding the intermediate oligomerized effluent from the first fixed-bed reactor to a second fixed-bed reactor in the first set of the fixed-bed reactor system; or
feeding the intermediate oligomerized effluent from the third fixed-bed reactor to a fourth fixed-bed reactor in the second set of the fixed-bed reactor system; and
recovering the oligomerized effluent,
wherein the first set of fixed-bed reactor and the second set of fixed-bed reactor are arranged in parallel.

14. The process of claim 13, further comprising:
operating the two fixed-bed reactors of the first set in an operation cycle while regenerating the zeolite catalyst in the two fixed-bed reactors of the second set in a regeneration cycle; and
switching the two fixed-bed reactors of the first set to the regeneration cycle and the two fixed-bed reactors of the second set to the operation cycle,
wherein in the operating and switching, one or more feeds selected from the group consisting of an air feed, a hydrogen feed, and a nitrogen feed is fed to the fixed-bed reactor system, and
a temperature of the operating and controlling is in a range from 200° C. to 600° C.

15. The process of claim 1, wherein a mass ratio of the first liquid fraction and the second liquid fraction ranges from 1:10 to 10:1.

16. The process of claim 1, wherein the zeolite catalyst is selected from the group consisting of zeolite beta, ferrierite, Y-zeolite, ZSM-5, HZSM-5, ZSM-22, MMT-zeolite, amorphous silica-alumina catalysts, surface modified zeolite catalysts thereof, and metal-doped zeolite catalysts thereof.

17. A system for producing bio or fossil fuels, the system comprising:
a fixed-bed reactor system containing a zeolite catalyst for oligomerization of one or more C3-C8 hydrocarbons to form an oligomerized effluent comprising one or more branched butene oligomers of propene, 1-butene, 2-butene, isobutene, pentene, hexene and octene;
a gas/liquid separation unit to separate an oligomerized effluent from the fixed-bed reactor system into a gas stream and a liquid stream, wherein the liquid stream comprises a first portion and a second portion,
an internal recycle system to recycle at least a second portion of the liquid stream to the fixed-bed reactor system;
a distillation unit to separate the first portion of the liquid stream into, a light fraction, a heavy fraction, and optionally a heavier fraction;
an external recycle system to recycle the light fraction to the fixed-bed reactor system;
a hydrogenation unit to hydrogenate the heavy fraction to form a hydrogenated product stream comprising one or more heavy branched paraffins; and
a fractionation system for fractionating the hydrogenated product stream into a light hydrogenated fraction, a jet or diesel fraction, and a heavy hydrogenated fraction.

18. The system of claim 17, wherein the external recycle system is configured to recycle a mixture of the second portion of the liquid stream and a portion of the heavy branched paraffins.

19. The system of claim 17, wherein the fixed-bed reactor system comprises:
three or more fixed-bed reactors in a staggered fashion, wherein the three or more fixed-bed reactors are operated in a cyclic operation including regeneration cycle;
a control system to control the operation of the three or more fixed-bed reactors such that no two fixed-bed reactors are in the regeneration cycle at the same time; and
one or more feed systems configured to provide a feed selected from the group consisting of an air feed, a hydrogen feed, and a nitrogen feed fed to the fixed-bed reactor system.

20. The system of claim 17, wherein the fixed-bed reactor system comprises:
two sets of fixed-bed reactors arranged in parallel, wherein
a first set and a second set each comprise two fixed-bed reactors,
the two fixed-bed reactors of the first set are in an operation cycle for the oligomerization while the two fixed-bed reactors of the second set are in a regeneration cycle to regenerate the zeolite catalyst;
a control system for switching the two fixed-bed reactors of the first set to the regeneration cycle and the two fixed-bed reactors of the second set to the operation cycle; and
one or more feeds selected from the group consisting of an air feed, a hydrogen feed, and a nitrogen feed fed to the fixed-bed reactor system.
